(19) United States
(12) Patent Application Publication
(10) Pub. No.: US 2015/0306503 A1
(43) Pub. Date: Oct. 29, 2015

(54) Manipulating Operation of a Virtual Event in a Social Networking Service

(71) Applicant: Crytek GmbH, Frankfurt/Main (DE)

(72) Inventor: Cevat Yerli, Frankfurt/Main (DE)

(21) Appl. No.: 14/262,556

(22) Filed: Apr. 25, 2014

(51) Int. Cl. A63F 13/792; G06Q 20/12; G06Q 50/00; H04L 29/08

(52) U.S. Cl. CPC A63F 13/792; H04L 67/10; H04L 67/22; G06Q 20/123; G06Q 50/01

(57) ABSTRACT

A method for manipulating operation of a virtual event provided by a social networking service, the virtual event being operable in accordance with each of a plurality of operation modes comprises operating the virtual event in accordance with a first one of the operation modes; providing data for rendering the virtual event on each of one or more electronic devices; providing data for simultaneously rendering, on each of the one or more electronic devices, a respective user interface, each user interface representing information on a fund related to modifying the operation mode of the virtual event, and each user interface further prompting to provide contribution to the fund; receiving, within a scheduled period of time, user input providing contribution to the fund; updating, based on the provided contribution, the information on the fund; and updating said one of the operation modes based on the updated information on the fund.

### FIELD

The present disclosure relates to a method and a system for providing a virtual event and manipulating operation thereof by means of a fund distributed via a social networking service.

### BACKGROUND

Social networking services provide a platform that can usually be accessed by users via electronic devices such as smartphones, tablets, consoles, PCs, or other internet enabled devices. By a social networking service, virtual events such as video games, virtual concerts, chat rooms, or the like can be rendered to a plurality of users, thus sharing the virtual event. In some instances, the users can participate in the virtual event, such as by providing user interaction and thus playing a video game, or by posting comments that then are rendered to the community. In the following, such users enabled to control the course of the virtual event by operating the virtual actions are referred to as “participants” of the virtual event.

While known systems may provide a virtual event controlled by one or more participants to an audience of one or more users accessing a social networking service, these users are generally excluded from an intervention in the virtual event, so that they are pure consumers of the virtual event, such as spectators and/or listeners. The known technology does not provide for a type of prompt access to a virtual event session other than participation therein on the one hand, and mere consumption thereof on the other hand.

There is, therefore, a need for a technique enabling a system to facilitate a further type of access to a virtual system, according to which an audience or a portion thereof can promptly influence the operation of the virtual event in a limited fashion, i.e., to an extent that can be regarded as intermediate, between pure consumption and detailed action control in the virtual event.

### SUMMARY AND INITIAL DESCRIPTION

The present disclosure addresses the above shortcomings of the prior art by various embodiments including a system and a method arranging a new type of access to the operation of a virtual event. Namely, this type of access allows for manipulating an operation mode of the virtual event, wherein merged contributions to a related fund during a scheduled period of time are decisive.

One aspect of the present disclosure is directed to a method for manipulating operation of a virtual event. The virtual event is provided by a social networking service and is operable in accordance with each of a plurality of possible operation modes. The method comprises operating the virtual event in accordance with a first one of the plurality of operation modes (the one operation mode also referred to as the “first” operation mode), and rendering the virtual event (operated in accordance with the first operation mode) on each of one or more electronic devices accessing the social networking service. The method further comprises rendering a user interface simultaneously on each of the one or more electronic devices. Each user interface thus rendered on a respective one of the one or more electronic devices represents information on a fund related to modifying the operation mode of the virtual event, and further prompts to provide contribution to the fund within a scheduled period of time. According to a method of the mentioned aspect, user input providing a contribution to the fund is received within the scheduled period of time, and the information on the fund is updated based on the provided contribution. Based on the updated information on the fund, the operation mode (in which the virtual event is operated) is then updated.

Another aspect of the present disclosure is directed to a system for providing a virtual event, the virtual event being operable in accordance with each of a plurality of operation modes. The system is configured to distribute, via a social networking service, data for rendering the virtual event, which is operated in accordance with one of the plurality of operation modes (the one operation mode also referred to as the “first” operation mode). The system is further configured to distribute, via the social networking service, data for rendering a user interface on each of a group of one or more electronic devices accessing the social networking service. Each user interface represents information on a fund which is related to modifying the operation mode of the virtual event (i.e., to modifying the one of the operation modes in accordance with which the virtual event is operated). Each user interface further prompts to provide a contribution to the fund within a scheduled period of time. The system is further configured to receive (e.g., via the social networking service), within the scheduled period of time, user input providing a contribution to the fund, to update the information on the fund based on the received user input (thus based on the provided contribution to the fund), and to update the operation mode (in which the virtual event is operated) based on the updated information on the fund.

The present disclosure thus allows for collecting user input data and incorporating such merged data into the operation process of the virtual event, by means of updating the operation mode of the virtual event based on the information on the fund. Thus, a new type of access to the virtual event being operated and rendered through the social networking service is provided, rendering an increased qualification and applicability thereof.

As a consequence, one or more users of the one or more electronic devices are enabled to collectively manipulate the operation of the virtual event by contributing to the fund.

The various operation modes may each determine details of the operation, such as the appearance of the virtual event, or they may constitute means that may be controlled via the interaction provided by one or more participants. Alternatively or additionally, each operation mode may define particular effects provoked by possible user interaction provided by a participant of the virtual event, may determine a group of participants allowed to provide user interaction, and/or may designate an extent of user interaction that one or more particular participants of the virtual event is (are) allowed to provide.

For instance, if the virtual event is a video game, it may be operated on various levels respectively defined by an operation mode. Such level may relate to some game assets, as, for example, a special weapon, a particular protection device, a specific capability, and/or some other game features provided to a virtual person or team appearing in the game and activated or controlled by the participant(s) of the game. Also, the operation mode may determine whether or not a virtual player or team is suspended from further contribution to the game, thus, whether the respective participant(s) is or are excluded from participation.

In the example that the virtual event is a virtual election among a plurality of virtual candidates presenting their respective arguments or performances via the social networking service, the respective operation mode may, for instance, define which of the possible virtual candidates (controlled by a participant of the virtual event) is allowed to present his or her arguments or performance, and/or how much time he or she is allotted to do so.

As is to be understood, there are many further examples of operation modes of these and other virtual events.

The virtual event may be operated by executing an application program, and each of the plurality of operation modes may be determined by at least one parameter of the application program. Consequently, updating the operation mode based on the updated information on the fund may include updating one or more parameters of the application program operating the virtual event.

The respectively shown instances of the user interface as respectively rendered on each one of the electronic devices (e.g., on a display thereof) may be different in appearance, such that the user interface may look different on a first one of the one or more electronic devices than on a second one of the electronic devices. For example, the appearance may depend on the processing capacities of the respective electronic device. Nonetheless, the user interface as rendered includes, for each of the electronic device, the information on the fund as mentioned above, and prompts to contribute to it. Preferably, each user interface is processed based on the same data stream, which may be distributed by one or more server(s), via the social networking service, to each of the one or more electronic devices.

Each user interface may be included in a field within another interface, such as an interface further including a field in which the operated virtual event is rendered.

The user input providing contribution to the fund may be received via one of the electronic devices rendering the user interface. For instance, the respective user interface rendered on each of the electronic devices may include a button or input field by means of which a user can deliver his desired contribution to the fund. The contribution may include points, votes, cash, itemdrops, or a combination of all of these. Moreover, the interface may prompt the user to specify a particular amount of contribution, such as a desired total of cash to be paid or a number of points the user wishes to award.

An exemplary system according to the present disclosure includes at least one server which is configured to operate the virtual event in accordance with the (first) one of the operation modes and/or with the updated operation mode. Preferably, the at least one server is configured to operate the virtual event in accordance with any (selected) one of the plurality of operation modes. Preferably, the at least one server is different from one or more servers hosting the social networking service, and is configured to cooperate with such servers, so as to render the operated virtual event via the social networking service. Alternatively, the at least one server may itself host the social networking service.

The social networking service (which may be hosted by at least one server) may be distributed through a telecommunications network, such as the Internet or any computer network, e.g., an intranet of a particular community.

The information on the fund preferably tracks any contribution received via anyone (or via a predetermined or otherwise specified group) of the one or more electronic devices during the scheduled period of time. Thus, the information on the fund may subsume, at any time of the scheduled period of time, all contributions so far received via the one or more electronic devices (possibly, of the specified group). That is, the information on the fund may represent the respectively current collective effort of the users of the one or more electronic devices for modifying the operation mode.

Each of the electronic devices may be a smartphone, a tablet, a console, a PC, or any Internet-enabled device such as a smart television, respectively configured to access the social networking service.

Preferably, the operation of the virtual event in accordance with the first operation mode is stopped while the user interface is being rendered on each of the one or more electronic devices, respectively.

In a preferred embodiment, updating said one of the operation modes based on the updated information on the fund comprises determining that the updated information on the fund is in accordance with at least one predetermined condition. If the updated information on the fund is in accordance with the at least one predetermined condition, the operation mode may be updated to be a second one of the plurality of operation modes different from the first one. If, however, it is determined that the information on the fund is not in accordance with said at least one predetermined condition, the updated operation mode may coincide with the first operation mode.

For example, such predetermined condition may be a predetermined minimum value of contribution provided during the scheduled period of time. The operation may be set to a second, different operation mode if and only if the information on the fund reflects that the subsumed contribution as received, from the users of one or more electronic devices (or from a specified group thereof), during the scheduled period of time is at least the predetermined minimum value.

For instance, one of the at least one predetermined condition may be given by a minimum number of votes or itemdrops collected, during the scheduled period of time, in the fund. These votes or itemdrops may respectively have been received as user input, e.g., via the one or more electronic devices. Alternatively or additionally, a predetermined condition may be given by a minimum cash value that has to be commonly afforded by the users of the one or more electronic devices, to modify the operation mode of the virtual event.

By means of the predetermined condition, the influence given to the users of the one or more electronic devices can be regulated by the access type devised by the present disclosure. Thereby, control of the operation of the virtual event can be improved.

According to a particular embodiment, at least one of the one or more predetermined conditions is determined based on the number of the one or more electronic devices.

Updating said one of the operation modes based on the updated information on the fund may comprise comparing the updated information on the fund with at least one condition emerging during the operation of the virtual event. For instance, the updated information on the fund may be compared (e.g., at the end of the scheduled period of time) with information on at least one other fund, such as the fund-collecting efforts of users of another group of one or more electronic devices, the other fund possibly likewise relating to modifying the operation mode of the virtual event. Thereby, for example, the group of users whose fund represents an increased collective effort as compared to the other group (or other groups) may be enabled to modify the operation mode in accordance with the interests of the group.

Preferably, the virtual event operated in the updated operation mode is rendered on each of the one or more electronic devices. Such rendering of the virtual event operated in the updated operation mode may include closing the user interface in each of the one or more electronic devices.

In a preferred embodiment, the virtual event is operated responsive to event interaction provided, by one or more participants of the virtual event, via at least one electronic device.

For instance, the virtual event may be a video game (such as a live session video game). The event interaction may be gaming interaction provided by one or more participants (individually or as a team of players). Rendering the video game on the one or more electronic devices may further comprise providing a live session video stream representing the live session video game to the one or more electronic devices in real-time.

Alternatively or additionally, the event interaction may include at least one comment being posted by one or more participants of a chat room, or at least one virtual performance provided in a virtual stage. The virtual event operated responsive to event interaction is preferably rendered in real-time on the one or more electronic devices, i.e., such that any delay with respect to the real user interaction is due to technical broadcast delay only, and without any scheduled lag time.

The users of the one or more electronic devices may thus view and/or listen to the virtual event including interaction of the participants, and they may influence the capabilities the participants are provided with. Accordingly, a new type of real-time reception of the virtual event (for instance, a video game, chat room, or virtual stage) is provided, which includes a control qualification given to the audience, as the latter can exert influence on the operation of the virtual event.

Preferably, the simultaneous rendering of a respective user interface on each of the one or more electronic devices is performed at a moment depending on a progress of the rendered virtual event. For example, if the virtual event is a video game, the rendering of the user interface may be performed at a particular strategic point in the game. Each respective user interface may thus provide, to users of the one or more electronic devices, an opportunity to influence the further operation of the virtual event by contributing to the fund.

According to a preferred embodiment, the user input providing contribution to the fund is received via a first one of the electronic devices that is blocked for event interaction during at least a portion of the virtual event. For instance, the first electronic device may be operated in a mode that disables participation in the virtual event during a phase of the virtual event (e.g., during an episode of a game) or during the entire virtual event operation. The influence of the users of the one or more electronic devices may thus be limited to manipulating the operation of the virtual event at predetermined slots, while the interactive operation of the virtual event is allocated to a particular group of participants only.

Therefore, the roles of the various users are designated so that interferences of user interactions are avoided. The operation of the virtual event is thus technically well controlled. Moreover, the quality of the participation and thus the enjoyment for the audience may be improved, as the arrangement allows for choosing enabled participants in accordance with some criteria, such as among competent or even professional participants only.

According to a preferred embodiment, after the information on the fund is updated, a second user input is received within the scheduled period of time, the second user input providing further contribution to the fund. The second user input may be received via the same electronic device as the first user input or via a different one of the one or more electronic devices. Based on the second user input, the information on the fund and the rendering thereof on each of the one or more electronic devices may then be updated again. Each user interface may thus represent, in real-time, a current state of the fund.

The scheduled period of time is preferably a short time interval. For instance, the scheduled period of time may be predetermined to be ten minutes or less, or five minutes or less, or only one minute or less.

The duration of the scheduled period may be determined based on at least one parameter reflecting a current workload of the social networking service, such as a number of electronic devices accessing the social networking service, the number of the one or more electronic devices to which the respective user interface is rendered, and/or an amount of data being processed by one or more servers providing the social networking service and/or the virtual event. Therefore, the step of rendering the user interface on each of the one or more electronic devices may comprise determining said at least one parameter and setting the duration of the scheduled period of time based on the at least one parameter. Thereby, the service may be relieved and thus stabilized.

For instance, when the at least one parameter indicates that the social networking service is heavily used, the scheduled period of time may be determined to be shorter than when the social networking service is balanced. Analogously, when there is a high number of electronic devices accessing the social networking service or the virtual event, the duration of the scheduled period of time may be shorter than when said number is small.

According to a preferred embodiment of the present disclosure, the scheduled period of time is a first scheduled period of time. The method may further include rendering, after updating the operation mode based on the updated information on the fund, the virtual event operated in accordance with the updated operation mode on each of the one or more electronic devices and thereafter, rendering simultaneously on each of the one or more electronic devices, a respective new user interface representing information on another fund related to modifying the operation mode of the virtual event, and prompting to provide contribution to the other fund within a further scheduled period of time. The duration of the further scheduled period of time may be different from the duration of the first scheduled period of time. The method may further comprise receiving, within the further scheduled period of time, user input providing contribution to the other fund, updating accordingly the information on the other fund, and updating the operation mode based on the updated information on the other fund. The system of the present disclosure may be configured accordingly.

The length of the scheduled period(s) of time may be determined based on a programmed situation (in the virtual event) that may trigger the rendering of the user interfaces on the one or more electronic devices. Accordingly, a differentiated influence (dependent on the respective situation in the virtual event) on the operation of the virtual event is provided to the user(s) of the one or more electronic devices.

The rendering of the user interface on each of the one or more electronic devices or the rendering of the virtual event each may trigger a starting point of the (respective) scheduled period of time.

According to a preferred embodiment, the one or more electronic devices form a first group of electronic devices, the fund related to modifying the operation mode of the virtual event is a first fund, and the scheduled period of time is a first scheduled period of time. On each of a second group of one or more electronic devices accessing the social networking service, a respective user interface may likewise be rendered, each user interface representing information on a second fund related to modifying the operation mode of the virtual event, and each user interface further prompting to provide contribution to the second fund within a second scheduled period of time. In a preferred embodiment, the first and the second group of electronic devices are different, such that preferably at least one of the groups includes an electronic device that is not included in the other group. In particular, the first and second groups may be disjoint (thus not include any electronic device in common).

The one or more users of the first group of electronic devices and the one or more users of the second group of electronic devices may thus be provided with an opportunity to contribute each to a respective fund related to manipulating the operation of the virtual event. Preferably, the virtual event operated in accordance with a first operation mode is rendered on each of the second group of the one or more electronic devices. The respective user interfaces may be rendered simultaneously on the one or more electronic devices of the first and of the second group of electronic devices. The first and second scheduled periods of time and their starting points are preferably equal; however, they may alternatively be different. By contributing to the respective fund, the respective users of the first and of the second group of electronic devices may thus compete with each other.

The updating of one of the operation modes of the virtual event may comprise closing, in each of the electronic devices of the second group, the respective user interface and/or quitting the second fund. Therefore, if the information on the first fund is in accordance with one or more predetermined conditions (which may mean that the users of the first group of electronic devices have complied with a requirement on the first fund) and/or if the information on the first fund reflects that the users of the first group of electronic devices have provided an increased collective effort as compared to the users of the second group of electronic devices (which may be determined by comparing, for example, at the end of the first scheduled period of time, the information on the first fund with the information on the second fund), the opportunity for contributing to the second fund may be closed for the users of the second group of electronic devices. Therefore, the users of the second group of electronic devices may lose the possibility to manipulate the operation of the virtual event.

The present disclosure thus provides a new means for operating a virtual event, which allows for friendly competition of the users of a first group and the users of a second group of electronic devices, as updating the operation mode based on the updated information on the first fund may be performed in accordance with interests of the users of the first group of electronic devices and opposing to interests of the users of the second group of electronic devices.

Preferably, the information on the second fund is rendered on each of the electronic devices of the first group, so that the users of the first group can control the current state of the second fund.

According to a preferred embodiment, it is determined whether the updated information on the first fund is in accordance with at least one first predetermined condition, and it is further determined whether the updated information on the second fund is in accordance with at least one second predetermined condition. The first and the second predetermined condition may coincide, or they may be different. For instance, the first predetermined condition may be selected based on a number of users of the first group of electronic devices, whereas the second predetermined condition may be selected based on the number of users of the second group of electronic devices.

In a preferred embodiment, the updating of one of the operation modes is based on both the updated information on the first fund and the updated information on the second fund. For instance, if both the first fund and the second fund comply with a respective predetermined condition, the operation mode of the virtual event may be updated in accordance with interests of both the first group of users and the second group of users. As a specific example, if the virtual event is a video game and both the first fund and the second fund comply with a respective predetermined condition, the operation mode of the video game may be updated such that both a participant (or team of participants) supported by the first group and a participant (or team of participants) supported by the second group of users obtain a respective particularly increased capability, such as a specific weapon, health, power, or device for the respectively controlled virtual player(s).

Each of the methods according to the present disclosure may be performed by executing instructions that may be stored in one or more computer-readable medium/media.

The present disclosure thus allows for operating a virtual event provided by a social networking service while offering to users of one or more electronic devices the opportunity of influencing the operation of the virtual event. However, the opportunity may be limited to manipulating an operation mode of the virtual event. Accordingly, users accessing the social networking service may be differentiated based on interaction possibilities they are provided with. Thereby, a crowd funding procedure is incorporated into the operation of the virtual event during the rendering thereof. A fund-based access to the event operation is thus created.

### BRIEF DESCRIPTION OF THE DRAWINGS

Further features and advantages of the present disclosure, as well as the structure and operation of various illustrative embodiments of the present disclosure, are described in more detail below with reference to the accompanying schematic drawings, wherein:

FIG. 1 illustrates a system providing a virtual event via a social networking service to a plurality of electronic devices in accordance with the present disclosure;

FIG. 2 is a flow diagram of a method in accordance with the present disclosure;

FIG. 3 is a flow diagram of an alternative method in accordance with the present disclosure; and

FIG. 4 exemplarily depicts a user interface that may be rendered in accordance with the present disclosure.

### DETAILED DESCRIPTION

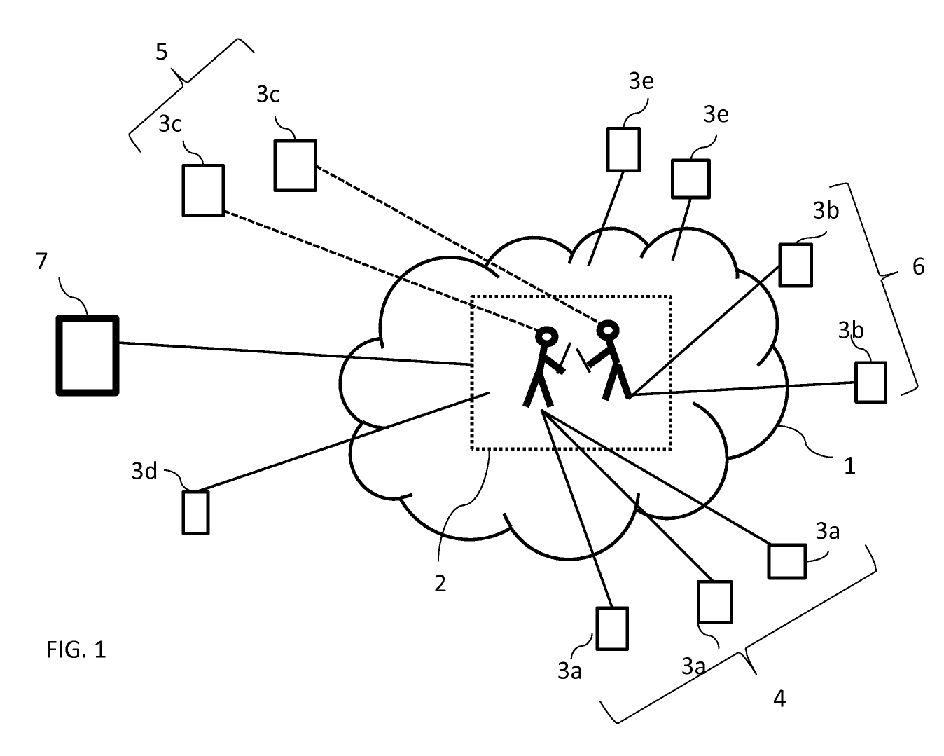

FIG. 1 schematically depicts a virtual event 2 being a video game provided via a social networking service 1. The virtual event may be operated by executing an application program and in accordance with a plurality of operation modes. The application program may be rendered by a system 7 that may distribute the operation data for the virtual event on the social networking service 1. As further depicted in FIG. 1, electronic devices 3a, 3b, 3c, 3d, and 3e access the social networking service 1. Therein, electronic devices 3a to 3d access the virtual event.

The electronic devices 3a to 3d are partitioned in four groups: Devices 3c each are enabled to participate in the rendered video game, which is indicated by the dotted lines. In the depicted example, devices 3c forming a group 5 of electronic devices may provide user interaction with the video game by controlling actions of respective virtual game figures. Electronic devices 3a are not enabled to control such actions. However, on each of the devices 3a forming a first group 4 of electronic devices, a user interface may be rendered, such as at a particular strategic point of the game. The respectively rendered user interface may provide information on a fund related to modifying an operation mode of the video game. For instance, the user interfaces rendered on devices 3a may prompt to provide contribution to a first fund related to modifying the operation mode, wherein such modification may result in supporting a virtual figure (or team) of the game (the virtual figure controlled by a participant via one of the devices 3c) with a particular asset, such as a weapon or protection device. The interface may further represent information on the fund (which may include an announced award such as a game asset related to a modified operation mode) and a scheduled period of time within which contribution to the fund can be provided.

Electronic devices 3b form a second group 6 of electronic devices likewise not enabled to control the virtual figures of the virtual events. Analogously to the electronic devices 3a of the first group 4 of electronic devices, electronic devices 3b of the second group 6 may each render a respective user interface representing information on a second fund related to modifying the operation of the virtual event and prompting to provide contribution to the second fund within the same or another scheduled period of time. Thereby, users of the electronic devices 3b of the second group 6 may be given the opportunity to collectively modify the operation mode of the video game, which may stand for providing a supported virtual figure or team (the virtual figure controlled by a participant via one of the devices 3c) with a special asset, such as a weapon or protection device, as possibly announced within the rendered information on the fund. The virtual figure or team supported by the users of the first group 4 of electronic devices 3a is preferably different from the virtual figure or team supported by the users of the second group 6 of electronic devices 3b.

The users of the respective devices 3a and 3b may then contribute to the respective funds by awarding contributions such as points, itemdrops, or cash donation to the fund. Each time a contribution is provided by one of the users of the electronic devices, the respective information on the fund and the user interfaces rendering this information are updated. If a predetermined condition relating to the respective fund is complied with within the scheduled period of time, the operation mode of the virtual event may be updated accordingly, so as to provide for a signalized support of the respective virtual player or team.

According to one embodiment, the entire period of time is awaited, and the users of each of the groups of electronic devices are awarded the announced modified operation mode if a respective predetermined condition relating to the fund is complied with. According to another embodiment, the interfaces prompting to provide contribution to the respective fund are closed when a first one of the funds complies with a predetermined condition. Accordingly, in this case the users of the other group of electronic devices would lose the possibility of modifying the operation mode and, therewith, of promoting their supported virtual player or team of the video game.

As is to be understood, a system may act analogously in cases where, different to the situation depicted in FIG. 1, the virtual event is another example, such as a chat room or a virtual stage.

Accordingly, the system provides different types of access to the virtual event, namely, the immediate control of the operation of the virtual event, as provided to electronic devices 3c, and the indirect access given to users of electronic devices 3a and 3b who may manipulate the conditions under which the virtual event is operated by means of modifying an operation mode. Further shown in FIG. 1 is electronic device 3d which accesses the virtual event in a pure spectator mode, so that a user thereof cannot influence the operation of the virtual event.

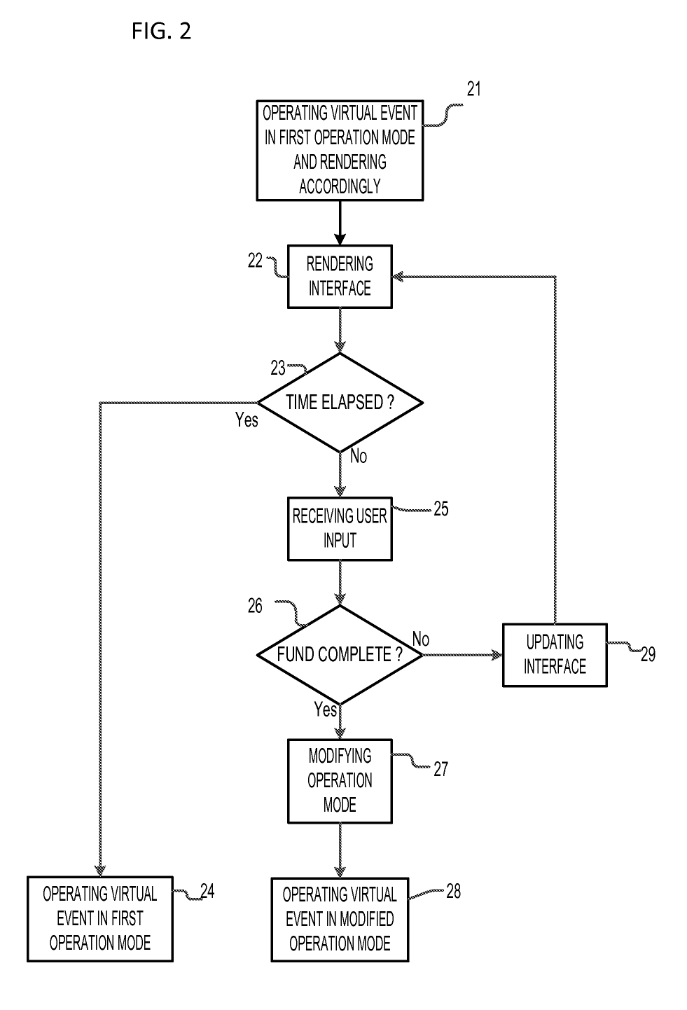

FIG. 2 shows a possible process of a method according to the present disclosure. In step 21, a virtual event is operated in accordance with a first one of a plurality of operation modes and rendered in real-time on each of one or more electronic devices accessing a social networking service. At a particular point in time or in a predetermined situation of the virtual event, in step 22, user interfaces are rendered on each of the one or more electronic devices. The rendering of the interfaces may include halting the operation and the rendering of the virtual event. The interfaces represent information on a fund related to modifying the operation mode of the virtual event, and they prompt to provide contribution to the fund within a scheduled period of time. The starting of the scheduled period of time may be triggered by the rendering of the user interfaces. Preferably, the duration of the scheduled period of time is about twenty minutes or ten minutes or less, possibly 5 minutes or one minute or less.

In step 23, elapse of the scheduled period of time is checked. If the scheduled period of time has elapsed, operation of the virtual event in the first operation mode is resumed in step 24. If the scheduled period of time has not yet elapsed, user input may be received, in step 25, via one of the electronic devices. Step 25 may further comprise updating information on the fund based on the received user input.

In step 26, it is checked whether or not the received user input has completed the fund, such as by providing contribution that makes the fund comply with one or more predetermined conditions. If so, in step 27 the operating mode of the virtual event is modified, and in step 28 the virtual event is operated in accordance with the modified operation mode and rendered accordingly on the one or more electronic devices. If, however, in step 26 it is determined that the fund is not yet complete (which determination may be made by determining that the updated information on the fund is not in accordance with the at least one predetermined condition), in step 29 each interface rendered on the one or more electronic devices is updated based on the updated information on the fund, and the method loops back to step 22 according to which the (updated) interfaces are rendered.

In embodiments according to which a respective user interface related to a second fund is simultaneously rendered to each of one or more electronic devices of a second group, step 27 of modifying the operation mode may include a step of closing the interfaces rendered on the electronic devices of the second group, thus quitting the second fund.

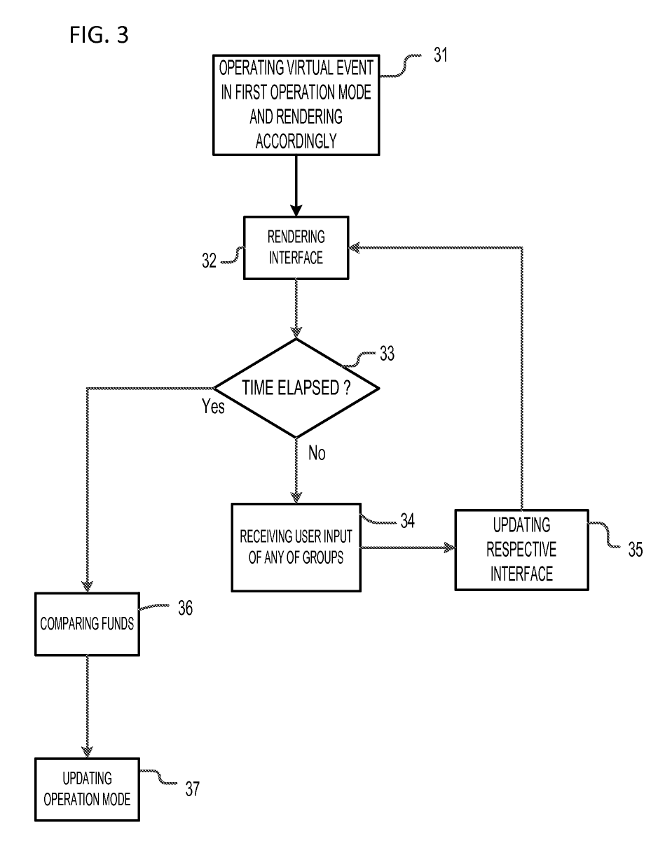

FIG. 3 shows an alternative method according to the present disclosure. Therein, (at least) two groups of one or more electronic devices are involved that may compete with one another.

In step 31, a virtual event is operated in accordance with a first one of a plurality of operation modes and rendered in real-time on each of one or more electronic devices of a first group and a second group, respectively accessing a social networking service. At a particular point in time or in a predetermined situation of the virtual event, in step 32, interfaces are rendered on each of the one or more electronic devices of each group. The rendering of the interfaces may include halting the operation and the rendering of the virtual event. The interfaces respectively rendered on the devices of the first group may represent information on a first fund related to modifying the operation mode of the virtual event, and prompt to provide contribution to the first fund within a scheduled period of time. Analogously, the interfaces respectively rendered on the devices of the second group may represent information on a second fund related to modifying the operation mode of the virtual event, and prompt to provide contribution to the second fund within the scheduled period of time. The starting of the scheduled period of time may be triggered by the rendering of the user interfaces. As in the example depicted in FIG. 2, the duration of the scheduled period of time may about twenty minutes or ten minutes or less, possibly 5 minutes or one minute or less. In step 33, elapse of the scheduled period of time is checked.

If it is determined in step 33 that the scheduled period of time has not yet elapsed, user input may be received, in step 34, from any one of the electronic devices of the first or the second group, thereby providing contribution to the first or second fund, respectively. The information on the respective user interfaces is then updated in step 35, and the method loops back to step 33.

If the scheduled period of time has elapsed, in step 36, the first fund and the second fund may be compared with one another and/or the first and/or the second fund may be compared with possibly different at least one predetermined condition, respectively. In step 37, the operation mode of the virtual event may then be updated based on predetermined criteria relating to the comparison. For instance, the predetermined criteria may define, based on a difference in the collective contribution result of the respective funds, whether the first or the second group of user interfaces is to be awarded an announced asset which may be implemented by a respectively modified operation mode.

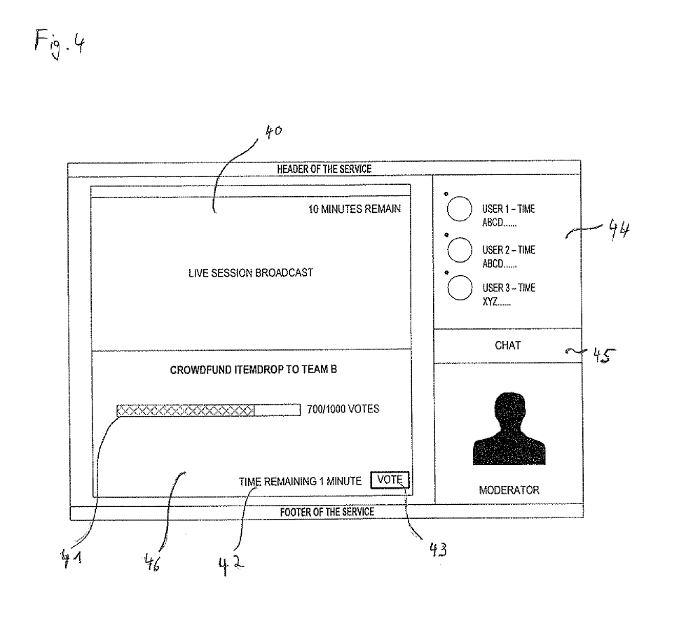

In FIG. 4, an exemplary user interface that may be rendered in accordance with the present disclosure on one or more electronic devices is depicted. The user interface includes a field 40 in which the operated virtual event is rendered as a live session broadcast. Moreover, a time remaining for the operation of the virtual event is indicated in said field 40. The user interface further includes a field 44 indicating users of the one or more electronic devices to which the user interface is rendered. A chat field 45 provides a possibility of exchange of comments of the users. Moreover, the user interface includes a field 46 providing information on a fund related to modifying the operation mode of the virtual event. The depicted exemplary field 46 includes a bar 41 indicating a current state of the fund. In the present example, the fund relates to votes to be provided by the users of the one or more electronic devices forming a first group that in the figure is called “team B.” In the depicted instance, a predetermined condition for completing the fund is a number of 1000 votes to be achieved, and at the depicted moment, 700 votes have already been achieved. By activating the field 43, a user may contribute to the fund. In field 42, the remaining time of the scheduled period of time is indicated.

As mentioned above, a related interface may be rendered on a second group of electronic devices. Such user interface may render information on a second fund related to modifying the operating mode of the virtual event. For instance, in the case of the illustrated example, the users of the group of electronic devices that at the end of the scheduled period of time have the most votes they could possibly achieve, the operating mode is modified in accordance with the goal of a fund. This group could, therefore, support its favorite participant or team of the virtual event.

In a particular example, the virtual event may be a first person shooter (FPS) gaming scenario that may be part of a live broadcast. At predetermined points of time or at points in the game (e.g., when one or more players have reached a predetermined score, and/or when a predetermined game scenario is reached in the game), the system may invite the audience to participate by crowd funding their favorite player(s) or team of players, with points, votes, cash, itemdrops, or a combination of any or all of these. This may enable the participant or team to obtain available game assets (which may be decided by the system) and help the participant(s) or team to be more competitive and therefore more likely to win the game. The game assets could be, but are not limited to, one or more special weapons, one or more items of specialized ammunition, special equipment such as surveillance or communication devices, extended health or invisibility, or a cash of supplies such as water, food, or medical supplies.

The system and method of the present disclosure may thus generate a crowd funding activity period by notification, by way of a user interface rendered on a display, to the audience. For example, at a strategic point of the game, e.g., when a game score between two participants is in a tie, a broadcaster may announce by way of the rendered user interfaces that the first team to reach (through crowd funding) a particular amount of points will receive a specific game asset.

The present disclosure thus allows members of an audience to support their favorite individual(s) or team of individuals (players) by providing or pledging support when prompted to do so by the system. Such contributions may thus be effected through a crowd funding concept in the form of points, votes, cash, itemdrops, etc., by means of which participants of the virtual event may be provided with game assets, thus ultimately giving the participants an advantage over their competitors by ensuring that the respectively supported participant or team gets a particular game asset before the opposition does. This creates a friendly competitive atmosphere for both supporters and players alike. The system interactions therein may be in real-time. Once the funding is complete, a message may be transmitted to a participant of the game, the message indicating information on the support received by the crowd fund.

While some embodiments have been described in detail, it is to be understood that aspects of the disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A method for manipulating operation of a virtual event provided by a social networking service, the virtual event being operable in accordance with each of a plurality of operation modes, the method comprising:
operating the virtual event in accordance with a first one of the operation modes;
providing data for rendering the virtual event operated in accordance with the first operation mode on each of one or more electronic devices;
providing data for simultaneously rendering, on each of the one or more electronic devices, a respective user interface, each user interface representing information on a fund related to modifying the operation mode of the virtual event, and each user interface further prompting to provide contribution to the fund within a scheduled period of time;
receiving, within the scheduled period of time, user input providing contribution to the fund;
updating, based on the provided contribution, the information on the fund; and
updating said one of the operation modes based on the updated information on the fund.

2. The method in accordance with claim 1, wherein updating said one of the operation modes based on the updated information on the fund comprises determining that the updated information on the fund is in accordance with at least one predetermined condition.

3. The method in accordance with claim 1, wherein updating said one of the operation modes comprises selecting a second one of the plurality of operation modes of the virtual event and operating the virtual event in accordance with the second operation mode.

4. The method in accordance with claim 1, further comprising providing data for rendering the virtual event, operated in the updated operation mode, on each of the one or more electronic devices.

5. The method in accordance with claim 1, wherein the virtual event is operated responsive to event interaction provided by one or more participants of the virtual event via at least one electronic device accessing the social networking service.

6. The method in accordance with claim 5, wherein the user input providing contribution to the fund is received via a first one of the electronic devices, which during the entire operation of the virtual event or during a portion thereof is blocked for event interaction.

7. The method in accordance with claim 1, wherein the scheduled period of time is ten minutes or less in length and/or wherein rendering the user interface on each of the one or more electronic devices triggers starting the scheduled period of time.

8. The method in accordance with claim 1, wherein the one or more electronic devices form a first group of electronic devices, wherein the fund related to modifying the operation mode of the virtual event is a first fund, and wherein the method further comprises:
providing data for rendering the virtual event operated in accordance with the first operation mode on each of a second group of one or more electronic devices accessing the social networking service; and
providing data for simultaneously rendering, on each of the one or more electronic devices of the second group, a respective user interface, each user interface representing information on a second fund related to modifying the operation mode of the virtual event, and each user interface further prompting to provide contribution to the second fund within the scheduled period of time.

9. The method according to claim 8, wherein the respective user interfaces are rendered simultaneously on the one or more electronic devices of the first group of electronic devices and on the one or more electronic devices of the second group of electronic devices.

10. The method according to claim 8, wherein for each of the electronic devices of the first group, the respective user interface further represents the information on the second fund.

11. The method according to claim 1, wherein the user input providing contribution to the fund is received via a first one of the electronic devices, and the method further comprises:
receiving, after updating the information on the fund and within the scheduled period of time, second user input providing contribution to the fund via the first electronic device or via a second one of the electronic devices, the second electronic device being different from the first one; and
updating again, for each of the one or more electronic devices and based on the second user input, the information on the fund.

12. One or more non-transitory, computer-readable media comprising instructions for a computing system to execute a method for manipulating operation of a virtual event provided by a social networking service, the virtual event being operable in accordance with each of a plurality of operation modes, the method comprising:
operating the virtual event in accordance with a first one of the operation modes;
providing data for rendering the virtual event operated in accordance with the first operation mode on each of one or more electronic devices;
providing data for simultaneously rendering, on each of the one or more electronic devices, a respective user interface, each user interface representing information on a fund related to modifying the operation mode of the virtual event, and each user interface further prompting to provide contribution to the fund within a scheduled period of time;
receiving, within the scheduled period of time, user input providing contribution to the fund;
updating, based on the provided contribution, the information on the fund; and
updating said one of the operation modes based on the updated information on the fund.

13. A system for providing access to a virtual event, the virtual event being operable in accordance with each of a plurality of operation modes, the system configured to:
distribute, via a social networking service, data for rendering the virtual event operated in accordance with one of the operation modes;
distribute, via the social networking service, data for simultaneously rendering a user interface on a group of one or more electronic devices accessing the social networking service, each user interface representing information on a fund related to modifying the operation mode of the virtual event, and each user interface further prompting to provide contribution to the fund within a scheduled period of time;
receive, within the scheduled period of time, user input providing contribution to the fund;
update, based on the received user input, the information on the fund; and
update, based on the updated information on the fund, said one of the operation modes.

14. The system according to claim 13, wherein updating said one of the operation modes based on the updated information on the fund comprises determining whether the updated information on the fund is in accordance with at least one predetermined condition.

15. The system according to claim 14, wherein updating said one of the operation modes comprises modifying the one of the operation modes and operating the virtual event in accordance with the modified operation mode, if the updated information is in accordance with the predetermined condition.

16. The system according to claim 13, which includes at least one server configured to operate the virtual event in accordance with the one of the operation modes and/or with the updated operation mode and/or with any one of the plurality of operation modes.

17. The system according to claim 13, wherein the scheduled period of time is ten minutes or less in length and/or wherein distributing data for rendering the user interface triggers starting the scheduled period of time.

18. The system according to claim 13, wherein the fund is a first fund, and the system is further configured to:
distribute, via the social networking service, data for simultaneously rendering, on each of one or more electronic devices of a second group of electronic devices accessing the social networking service, a user interface corresponding to a second fund related to modifying the operation mode of the virtual event, each user interface corresponding to the second fund representing information on the second fund and prompting to provide contribution to the second fund within a second scheduled period of time;
receive, via the social networking service and within the second scheduled period of time, user input providing contribution to the second fund; and
update the information on the second fund based on the contribution to the user input providing contribution to the second fund.

19. The system according to claim 18, wherein the updating of said one of the operation modes is based on the updated information on the second fund further to the updated information on the first fund.

20. The system according to claim 18, further configured to:
determine whether the updated information on the first fund is in accordance with at least one first predetermined condition; and
determine whether the updated information on the second fund is in accordance with at least one second predetermined condition.
